(19) United States
(12) Patent Application Publication
(10) Pub. No.: US 2014/0263917 A1
(43) Pub. Date: Sep. 18, 2014

(54) SMALL-SIZED PORTABLE VACUUM-HOLDING DEVICE

(71) Applicant: HON HAI PRECISION INDUSTRY CO., LTD., New Taipei (TW)

(72) Inventor: CHIH-HAO CHU, New Taipei (TW)

(73) Assignee: HON HAI PRECISION INDUSTRY CO., LTD., New Taipei (TW)

(21) Appl. No.: 14/192,752

(22) Filed: Feb. 27, 2014

(30) Foreign Application Priority Data
Mar. 15, 2013 (TW) 102109185

(51) Int. Cl. F16M 13/02

(52) U.S. Cl. CPC F16M 13/02
USPC 248/363

(57) ABSTRACT

A vacuum-holding device includes a nozzle body and a vacuum generating device. The nozzle body defines a first air channel. In the vacuum generating device, a piston head received within the first air channel, a piston ring is sleeved on the piston head and making an air-tight seal between the piston head and the nozzle body, a piston rod connecting the piston head with an operation board, a guiding device for guiding the piston head along with the piston rod to move along a depth direction of the first air channel, and an actuation device is included in the vacuum generating device for quickly pulling the piston head along with the piston ring out of the first air channel after the piston head along with the piston ring is pushed in the first air channel by operating the operation board.

### BACKGROUND

1. Technical Field

The present disclosure relates to vacuum-holding technologies, and particularly to a small-sized and portable vacuum-holding device.

2. Description of Related Art

Vacuum-holding devices include a nozzle and a vacuum source, such as a bulky unportable air compressor. The nozzle communicates with the vacuum source using a pipe and thus can hold objects utilizing a negative pressure generated by the air compressor. Due to employment of the air compressor, the air holding devices are typically bulky and, a working distance of the vacuum-holding devices is limited to a length of the pipe, around the air compressor.

Therefore, it is desirable to provide a vacuum-holding device that can overcome the above-mentioned problems.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is an isometric view of a vacuum-holding device, according to an embodiment.

FIG. 2 is an exploded view of the vacuum-holding device of FIG. 1.

FIG. 3 is a cross-sectional view taken along a line III-III of FIG. 1.

FIG. 4 is a cross-sectional view taken along a line IV-IV of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

Embodiments of the present disclosure will be described with reference to the drawings.

FIGS. 1-4 show a vacuum-holding device 100, according to an embodiment. The vacuum-holding device 100 includes a nozzle body 110 and a vacuum generating device 120.

In this embodiment, the vacuum body 110 has a rectangular tube configuration and includes a first section 111 and a second section 112 perpendicularly connecting the first section 111.

A configuration of the vacuum body 110 is not limited to this embodiment but can take other suitable forms, for example, in other embodiments, the vacuum body 110 can be a circular tube configuration. A connection manner between the first section 111 and the second section 112 is not limited to this embodiment, for example, in some embodiments, the first section 111 and the second section 112 can be collinearly connected with each other.

The first section 111 includes a first end surface 101 spaced from and facing away from the second section 112. The first section 111 defines a straight first air channel 113, two first guiding holes 1110, and two first threaded holes 132 in the first end surface 101. Depth directions of the first air channel 113, the first guiding holes 1110, and the first threaded holes 132 are substantially perpendicular to the first end surface 101. The first air channel 113 is deeper than the first guiding hole 1110 and the first guiding hole 1110 is deeper than the first threaded hole 132. The first air channel 113 has a circular-hole configuration and is generally positioned at a central portion of the first end surface 101. The first guiding holes 1110 and the first threaded holes 132 are alternatively equidistantly arranged, surrounding the first air channel 113.

The first section 111 also defines two first retaining grooves 151 in the first end surface 101. Each first retaining groove 151 is substantially circular and is coaxial with one of the first guiding holes 1110 with a larger diameter than a diameter of the first guiding holes 1110.

Configurations of the first air channel 113, the first guiding holes 1110, and the first threaded holes 132 are not limited to this embodiment but can take other suitable forms in other embodiments. For example, the first air channel 113 may be rectangular hole, and more than two first guiding holes 1110 and first threaded holes 132 may be employed and arranged as desired.

The second section 112 has a second end surface 102 spaced from and facing away from the first section 111. The second section 112 defines a second air channel 114 and a second retaining groove 161. Depth directions of the second air channel 114 and the second retaining groove 161 are substantially perpendicular to the second end surface 102. The second retaining groove 161 is shallower than the second air channel 114. The second air channel 114 has a circular-hole configuration and is generally located at a central portion of the second surface 102. The first channel 113 and the second air channel 114 communicate with each other. The second retaining groove 161 is annular and surrounds the second air channel 114.

Configurations of the second air channel 114 and the second retaining groove 161 are not limited to this embodiment but can take other suitable forms in other embodiments, for example, the second air channel 114 may be a rectangular hole.

The vacuum generating device 120 includes a piston rod 121, an operation board 122, a piston head 123, a piston ring 124, a guiding device 130, an actuating device 150, and a buffer ring 160.

The piston rod 121 is circular and has a diameter slightly smaller than a diameter of the first air channel 113. The piston rod 121 has a first threaded end 121a and defines a second threaded hole 1211 in an end surface thereof opposite to the first threaded end 121a.

In other embodiments, the piston rod 121 can take other suitable configurations, such as a rectangular rod, for example.

The operation board 122 is substantially circular and defines a third threaded hole 1221, two fourth threaded holes 1222, and two second guiding holes 1223 extending therethrough, corresponding to the first air channel 113, the first guiding holes 1110, and the first threaded holes 132 in shape, size, and position. That is, the third threaded hole 1221 is generally positioned at a central portion of the operation board 122, and the fourth threaded holes 1222 and the second guiding holes 1223 are alternatively and equidistantly arranged, surrounding the third threaded hole 1221.

However, configurations of the third threaded hole 1221, the fourth threaded holes 1222, and the second guiding holes 1223 are not limited to this embodiment but can be changed depending on changes of the first air channel 113, the first guiding holes 1110, and the first threaded holes 132.

The piston head 123 includes a cylindrical section 125 and a threaded section 126 coaxially extending from one end of the cylindrical section 125. A diameter of the cylindrical section 125 is smaller than the diameter of the piston rod 121 but is larger than a diameter of the threaded section 126. The threaded section 126 is configured for engaging with the second threaded hole 1211.

The piston ring 124 has an inner diameter slightly smaller than the diameter of the cylindrical section 125, an outer diameter slightly larger than the diameter of the first air channel 113 and is made of resilient material.

The guiding device 130 includes two auxiliary piston rods 131 and two guiding rods 133.

Each auxiliary piston rod 131 has a diameter slightly smaller than a diameter of the first guiding hole 1110. Each auxiliary piston rod 131 includes a second threaded end 131b. The second threaded end 131b is configured for engaged with the third threaded holes 1222.

Each guiding rod 133 includes a third threaded end 133d and a limiting head 1331 formed at an end opposite to the third threaded end 133d. A diameter of the second guiding hole 1223 is larger than a diameter of the guiding rod 133 but is smaller than a diameter of the limiting head 1331. The third threaded end 133d is configured for engaging with the first threaded hole 132.

The actuation device 150 includes two coil springs.

In assembly, the first threaded end 121a is threadedly engaged with the third threaded hole 1221, the threaded section is threadedly engaged with the second threaded hole 1211, and the piston ring 124 is interferingly sleeved on the cylindrical section 125.

The second threaded ends 131b are threadedly engaged with the fourth threaded holes 1222 and the coil springs of the actuation device 150 are slidably sleeved on the auxiliary rod 131.

The piston ring 124 along with the piston head 123 is interferingly inserted into the first air channel 113 to make an air-tight seal between the piston ring 124 and the first section 111. The auxiliary rods 131 are inserted into the first guiding holes 1110 and an end of each coil spring of the actuation device 150 is retained in one of the first retaining grooves 151.

The third threaded ends 133d are slightly inserted through the second guiding holes 1222 and are threadedly engaged with the first threaded holes 132.

The buffer ring 160 is made of resilient material and is retained within the second retaining groove 161.

In operation, the operation board 122 can be operated to push towards the first section 111, guided by cooperation between the auxiliary rods 131 and the first guiding holes 1110 and by cooperation between the guiding rods 133 and the second guiding holes 1222. During the push operation, air is pushed out from the first air channel 112 and the second air channel 114 and the coil spring of the actuation device 150 is compressed. After the push operation, the vacuum-holding device 100 is movable such that the second end surface 102 contacts an object. Then, the operation board 122 is released, the piston ring 124 along with the piston head 123 is quickly pulled out of the first air channel 113, driven by the coil springs of the actuation device 150. As such, a negative pressure is generated due to the movement of the piston ring 124.

Configuration of the vacuum generating device 120 is not limited to this embodiment but can be changed according to need and depending on changes to the nozzle body 110.

It will be understood that the above particular embodiments are shown and described by way of illustration only. The principles and the features of the present disclosure may be employed in various and numerous embodiments thereof without departing from the scope of the disclosure. The above-described embodiments illustrate the possible scope of the disclosure but do not restrict the scope of the disclosure.

What is claimed is:

1. A vacuum-holding device, comprising:
a nozzle body comprising a first end surface and a second end surface, the nozzle body defining a straight first air channel in the first end surface, and defining a second air channel communicating with the first air channel in the second end surface, the second end surface being configured for holding objects; and
a vacuum generating device, comprising:
a piston head received within the first air channel;
a piston ring sleeved on the piston head and making an air-tight seal between the piston head and the nozzle body;
an operation board;
a piston rod partially received in the first air channel and connecting the piston head with the operation board;
a guiding device for guiding the piston head to move along a depth direction of the first air channel; and
an actuation device for quickly pulling the piston head out of the first air channel after the piston head is pushed into the first air channel by operating the operation board.

2. The vacuum-holding device of claim 1, wherein the nozzle body comprises a first section and a second section perpendicularly connecting the first section, the first end surface is positioned on the first section, opposite to the second section, and the second end surface is positioned on the second section opposite to the first section.

3. The vacuum-holding device of claim 1, wherein the piston rod comprises a first threaded end, the operation board defines a third threaded hole corresponding to the first air channel, and the first threaded end threadedly engages with the third threaded hole.

4. The vacuum-holding device of claim 3, wherein the piston rod defines a second threaded hole in an end surface thereof opposite to the first threaded end, the piston head comprises a cylindrical section and a threaded section extending from one end of the cylindrical section, the threaded section threadedly engages with the second threaded hole, and the piston ring is interferingly sleeved on the cylindrical section.

5. The vacuum-holding device of claim 4, wherein a diameter of the cylindrical section is smaller than a diameter of the piston rod but is larger than a diameter of the threaded section.

6. The vacuum-holding device of claim 1, wherein the nozzle body defines two first threaded holes in the first end surface, the operation board defines two second guiding holes corresponding to the first threaded holes, the guiding device comprises two guiding rods, each of which comprises a third threaded end and a limiting head formed at an end thereof opposite to the third threaded end, the third threaded ends insert through the second guiding holes and threadedly engages with the first threaded holes, and the operation board is slidable on the guiding rods, limited by the first end surface and the limiting heads.

7. The vacuum-holding device of claim 1, wherein the nozzle body defines two first guiding holes in the first end surface, the operation board defines two fourth threaded holes corresponding to the first guiding holes, the guiding device comprises two auxiliary rods, each of which is slidably partially received in one of the first guiding holes and comprises a second threaded end threadedly engaged with one of the fourth threaded holes.

8. The vacuum-holding device of claim 7, wherein the actuation device comprises two coil springs, each of which is slidably sleeve on one of the auxiliary rods and compressed between the nozzle body and the operation board.

9. The vacuum-holding device of claim 8, wherein the nozzle body defines two first retaining grooves, each of which is annular and coaxially surrounds one of the first guiding holes, and each coil spring is retained within one of the first retaining grooves.

10. The vacuuming-holding device of claim 1, wherein the nozzle body defines a second retaining groove in the second end surface, which is annular and coaxially surrounds the second air channel, the vacuum-holding device comprises a buffer ring retained in the second retaining groove.
